(19) United States
(12) Patent Application Publication
(10) Pub. No.: US 2012/0207548 A1
(43) Pub. Date: Aug. 16, 2012

(54) IN-PIPE EVERSION DEVICE AND METHOD OF USE

(76) Inventor: Doug BECK, Paoli, IN (US)

(21) Appl. No.: 13/025,241

(22) Filed: Feb. 11, 2011

(51) Int. Cl. F16L 55/18

(52) U.S. Cl. 405/184.2

(57) ABSTRACT

An eversion and installation device and method for in-pipe use to line an underground pipe with a resin impregnated lining tube. A pressure vessel has a slotted gasket and a flapper, along with rollers allowing a collapsed lining tube to be extended into and through the vessel and cuffed and secured to the leading end of the vessel. The vessel is then lowered through a manhole passage onto the floor or trough of the pipe before fluid pressure is applied to evert the tube into the pipe.

### CROSS-REFERENCE TO RELATED APPLICATIONS

None.

### FIELD OF THE INVENTION

This invention relates generally to the lining of underground pipes and is directed more particularly to a method and apparatus that lines a pipe with an eversion device that is located in the pipe during use.

### BACKGROUND OF THE INVENTION

Various devices and techniques have been used to repair and/or rehabilitate sewer pipes and other underground pipes. One technique that has been popular, primarily because it avoids the need for costly and disruptive excavation, involves the use of a resin impregnated liner which provides a new lining that can eliminate leaks in the pipe. The liners are often installed using fluid pressure which everts the liner and presses it against the interior wall surface of the pipe while the resin cures to complete the installation.

As exemplified by U.S. Pat. No. 6,942,426 to Kampbell et. al., the equipment that is used for eversion of the lining tube is often located at the surface a significant distance above the sewer pipe. The liner is everted by the device and extended downwardly through the manhole and manhole passage to the sewer pipe, whereat it is then turned horizontally for lining of the Pipe.

Although this technique has been used frequently, it is not completely free of problems. Perhaps most notable is the waste of material. The manhole passage is typically 5-20 feet deep, so this entire length of lining material that extends in the manhole passage must be cut off and scrapped. Such waste is a significant impediment to achieving an economical sewer pipe rehabilitation and, in fact, can be a substantial deterrent to use of the process at all in many applications.

Devices that are placed in the sewer pipe during operation to evert the lining tube are costly and elaborate and generally practical only for large sewer pipes. Often, workers are required to enter the sewer pipes to set up equipment or perform other tasks, and this is undesirable for a variety of reasons

### SUMMARY OF THE INVENTION

The present invention is directed to the provision of a method and apparatus that can be used while positioned in an underground pipe to evert and install resin impregnated lining tubes in an effective and efficient manner with minimal material waste.

In accordance with a preferred embodiment of the invention, a pressure vessel is equipped with a slotted gasket through which a collapsed flexible lining tube can be threaded into the body of the vessel. The leading end of the liner can be cuffed and turned back over the leading end of the vessel and secured in place by a clamping band or another suitable fastener. The vessel may be equipped with a pair of rollers around which the liner can be drawn.

Once the lining tube has been secured in this manner to the pressure vessel, the vessel can be lowered through a manhole passage and placed on the floor or trough of the sewer pipe with the cuffed end of the tube pointing in the direction to be lined. Air or another fluid under pressure can then be applied to the pressure vessel to push the liner out of the vessel and into the sewer pipe as the liner is everted. The fluid pressure maintains the everted liner against the interior wall of the sewer pipe.

The pressure vessel may include a flapper which is closed by the fluid pressure to seal the gasket slot as soon as the trailing end of the liner has passed through the slot into the vessel. Once the entirety of the liner has been everted in the pipe, steam or another fluid may be applied to the pressure vessel and to the interior of the liner for curing of the resin.

This process and use of the in pipe eversion device in this way has the important advantage of minimizing material waste. Because the device is in the sewer pipe, there is no need to provide lining in the manhole passage at either end, so this waste of material that occurs with surface mounted devices is avoided. The provision of rollers and their arrangement to effect a gradual change of direction of the lining tube reduces the frictional resistance and thus reduces the force and energy required to carry out the lining process.

Other and further objects of the invention, together with the features of novelty appurtenant thereto, will appear in the course of the following description.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views:

FIG. 1 is a perspective view of an in pipe eversion device which is constructed and may be used in accordance with one embodiment of the present invention;

FIG. 2 is an elevational view of the eversion device shown in FIG. 1;

FIG. 3 is an elevational view showing the eversion device in place resting on the floor of a sewer pipe in preparation for lining of the pipe by eversion of a lining tube;

FIG. 4 is an elevational view of the slotted gasket of the eversion device; and

FIG. 5 is an elevational view of the flapper of the eversion device.

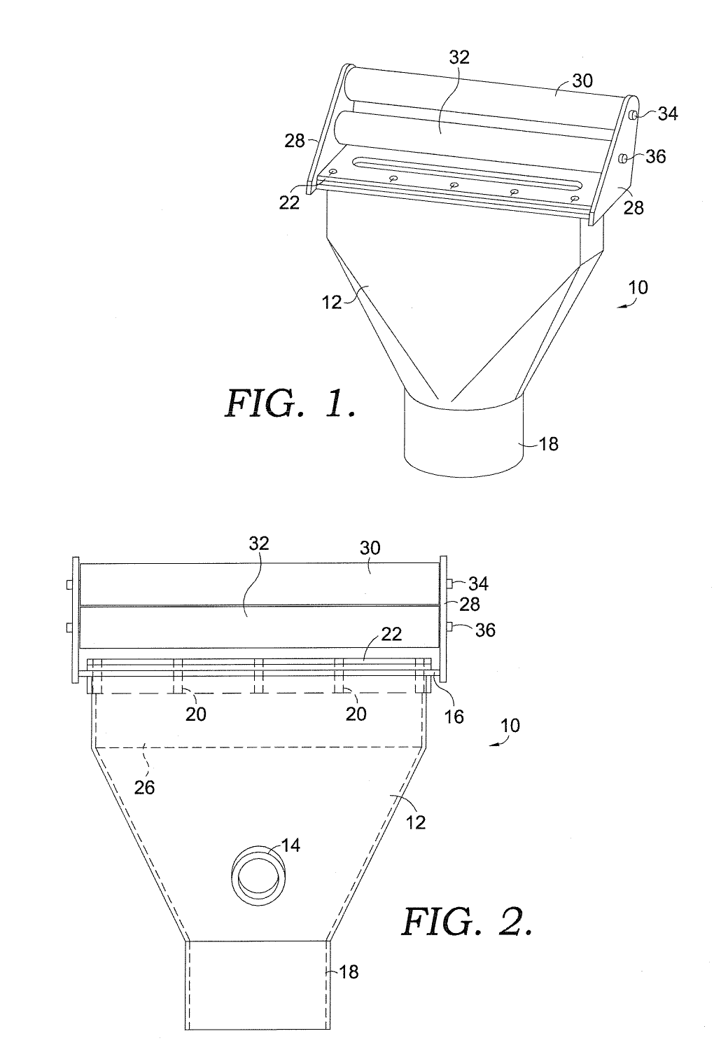

### DESCRIPTION OF THE PREFERRED EMBODIMENT

Referring now to the drawings in more detail, numeral 10 generally designates an eversion device which may be used in accordance with the present invention for the installation of a flexible lining tube in an underground pipe such as a sewer pipe. The eversion device 10 may take the form of a pressure vessel having a funnel shaped body 12. The body 12 is hollow and is provided on its upper side with a fitting 14 which may be used to apply air, steam, and/or other fluids to the hollow entire of the body 12.

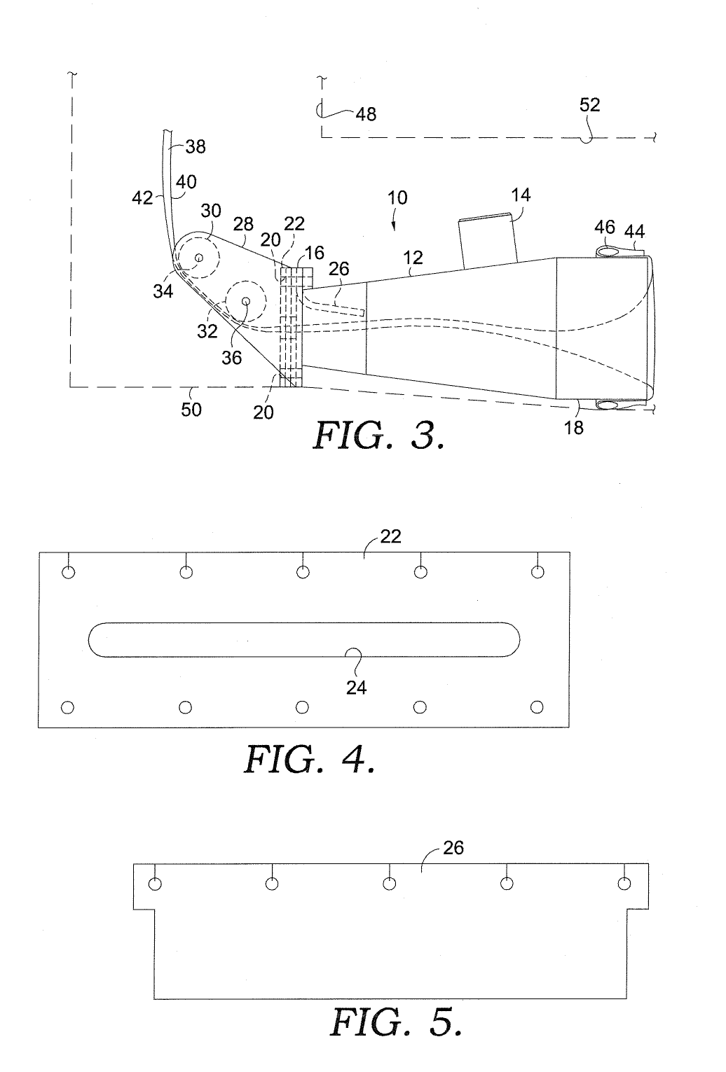

As best shown at FIG. 3, a flange 16 is provided on one end of the body 12 which is the trailing end of the eversion device 10 when the device is being used for the eversion and installation of the lining tube. The body 12 tapers from the end that connects with flange 16 and is provided on its opposite or leading end with a generally cylindrical fitting 18. The fitting 18 may be integral with the body 12 or it may be constructed as a separate part that is connected by a suitable means with the leading end of the body 12.

Connected with the flange 16 by bolts 20 or other suitable fasteners is a slotted gasket 22. As best shown in FIG. 4, the gasket 22 may take the form of a generally flat, rectangular plate having an elongated slot 24 formed through it. The length and width of the slot 24 are selected to accommodate the size of the lining tube that is to be installed. The device may be constructed so that gaskets having different size slots may be used interchangeably.

A flapper 26 is connected with the flange 16, preferably by the same bolts 20 that are used for connection of the gasket 22. However, as shown in FIGS. 3 and 5, the flapper 26 is bolted to the flange only along one edge. The flapper 26 is thus free to move away from the slot 20 in order to accommodate extension of the lining tube through the slot as will be explained more fully. The flapper 26 has a generally flat configuration such that it can lie flatly against the surface of the gasket 22 and thereby seal the slot 24, again as will be explained more fully. Both the gasket 22 and the flapper 26 may be constructed of silicone material or any other suitable material.

Attached to the opposite side edges of the flange 16 are a pair of parallel bracket plates 28. Mounted between the bracket plates 28 are a pair of spaced apart rollers 30 and 32 which rotate on respective shafts 34 and 36 extending between the bracket plates 28. As best shown in FIG. 3, the rollers are located such that a straight line extending between their shafts 34 and 36 is oriented at approximately 45° relative to a straight line extending between the centers of the trailing and leading ends of the body 12.

In use, the eversion device 10 facilitates the eversion and installation of a lining tube 38 (see FIG. 3) which may be constructed of a suitable material which is impregnated with resin in a manner well known in the industry. The tube 38 is initially arranged in a collapsed condition in which its walls 40 and 42 are overlaid flatly against one another. The leading end of the tube 38 may be drawn beneath and against the two rollers 30 and 32 and extended closely through the gasket slot 24 into the interior of the body 12. The leading end of tube 38 may be pulled out of the fitting 18 and arranged in a cuff 44 which may be turned back on itself and placed against the outside surface of the fitting 18 as shown in FIG. 3. A clamping band 46 or other suitable fastener may be used to secure the cuff 44 in place against the outside surface of the fitting 18. The flapper 26 is able to move away from the gasket slot 24 as shown in FIG. 3 in order to accommodate extension of the lining tube 38 through the slot 24 and into the interior of the eversion body 12.

After the leading end portion of the tube 38 has been secured to the eversion device in this manner, the device may be lowered through a manhole or manhole passage 48 (FIG. 3) until the device 10 rests on the floor or trough 50 of a generally horizontal underground pipe such as a sewer pipe 52. The eversion device 10 is oriented with its end fitting 18 in a leading position relative to the direction in which the tube 38 is installed in the pipe 52. The portion of tube 38 that extends in the body 18 is oriented horizontally in line with the longitudinal axis of the sewer pipe 52, while the portion of tube 38 that extends in the manhole passage 48 is oriented vertically. The orientation of the two rollers 30 and 32 on a line that is at 45° to both the vertical and horizontal portions of the lining tube 38 provides a gradual change of direction of the tube through a 90° angle, with the tube being turned at approximately 45° around the first roller 30 and then an additional 45° around the other roller 32. This gradual change of direction and the use of the low friction rollers results in a significant reduction in the frictional resistance to the eversion process and enhances the efficiency of the process.

When the eversion device 10 is in place on the floor or trough 50 of the sewer pipe 52, a hose that provides air or another fluid under pressure is connected to the fitting 14 and, through the fitting, to the interior of the body 12. The fluid pressure pushes the tube 38 through and out of the body 12 as it everts the tube, thus extending the tube out of the eversion device through the length of the sewer pipe 52. The fluid pressure maintains the tube 38 against the interior surface of the sewer pipe wall as the eversion and installation of the tube continues.

When approximately one-half of the length of the tube 38 has been installed, the trailing end of the tube passes through the slot 24. At this time, the flapper 26 is closed and presses against the face of the gasket 22, thus sealing the slot 24 to maintain the pressure in the body 12. The fluid pressure acts to press the flapper 26 against the gasket face and maintains the seal throughout the remainder of the eversion and installation process.

Once the tube 38 has been fully everted and installed, its leading end may be sealed by suitable techniques, and steam is preferably then applied under pressure to the fitting 14 and through the interior of the tube 38 in order to enhance curing of the resin. When the tube 38 has been fully cured, it is permanently secured in place against the inside surface of the sewer pipe 52 and the end of the tube 38 is cut to provide a lining for the sewer pipe.

When the tube 38 has been installed in this manner, has cured, and the end of the liner is cut, the eversion device 10 can be withdrawn through the manhole passage 48 and used again. Because the device 10 is located within the sewer pipe 52 as it everts the tube 38, there is no need for any part of the tube 38 to be installed in the manhole passage 48 either at the installation end or the opposite end, and the many feet of material that are wasted using prior art techniques need not be wasted in the process of the present invention. In addition, the use of device 10 minimizes the necessity of a technician to enter into and work in such a confined and dangerous space.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A method of installing a flexible lining tube in an underground pipe extending generally horizontally, said method comprising:
extending the lining tube in a collapsed condition through a pressure vessel;
forming a cuff on an end portion of the lining tube;
attaching said cuff to an end of the pressure vessel;
lowering the pressure vessel through a manhole passage into the pipe until the pressure vessel rests in the pipe in a generally horizontal orientation; and
applying fluid pressure to the pressure vessel to effect eversion of the lining tube and extension thereof into the pipe.

2. A method as set forth in claim 1, including the step of passing the lining tube around at least one roller before extending the lining tube through the pressure vessel with said roller arranged to effect a change of direction of the lining tube from a generally vertical orientation in the manhole passage to a generally horizontal orientation in the pipe when the pressure vessel rests therein.

3. A method as set forth in claim 2, including the step of sealing the pressure vessel after the entirety of the lining tube is extended therethrough.

4. A method as set forth in claim 1, including the step of sealing the pressure vessel after the entirety of the lining tube is extended therethrough.

5. A method as set forth in claim 1, wherein said pressure vessel has a gasket opening through which the lining tube is extended into the vessel in said collapsed condition, and including the step of sealing said gasket opening when the entirety of the lining tube has been extended therethrough.

6. A method of installing a flexible lining tube in a generally horizontal underground pipe having a floor and a manhole passage providing access to the pipe, wherein the lining tube has an initially collapsed condition in which walls of the tube are overlaid in a double ply configuration, said method comprising:
extending a leading end of said tube in the collapsed condition thereof into a pressure vessel through a gasket opening in the vessel;
forming a cuff in said leading end;
securing said cuff to an exterior surface of the vessel at a location thereon downstream from said gasket opening;
lowering said vessel through said manhole opening until the vessel rests on the floor of the pipe with the lining tube extending generally horizontally through the vessel from said gasket opening to said cuff;
applying fluid pressure to said pressure vessel to evert the lining tube and extend the tube into the pipe; and
sealing said gasket opening when a trailing end of the tube has passed therethrough.

7. Apparatus for installing a flexible lining tube in an underground pipe extending generally horizontally, said apparatus comprising:
a pressure vessel having a first end for receiving the lining tube in a collapsed condition and a second end to which the lining tube may be connected, said vessel having a construction to lie in the pipe with a passage in the vessel extending in a generally horizontal orientation between said first and second ends;
a gasket on said first end of the vessel having a gasket opening through which the lining tube may be extended;
a fitting on said vessel for accommodating fluid pressure applied to said passage for effecting eversion of the lining tube and extension of the tube generally horizontally into the pipe; and
a flapper on said first end of the vessel acting to seal said gasket opening when the lining tube is not extended therethrough.

8. Apparatus as set forth in claim 7, including at least one roller on said pressure vessel arranged to effect a change in direction of said lining tube of approximately 90°.

9. Apparatus as set forth in claim 7, including a pair of spaced apart rollers on said pressure vessel around which the lining tube may be drawn, said rollers having centers located on a line oriented at approximately 45° relative to a line extending between centers of said first and second ends of the vessel.
